(19) United States
(12) Patent Application Publication
(10) Pub. No.: US 2026/0052418 A1
(43) Pub. Date: Feb. 19, 2026

(54) MINIMIZATION DRIVE TEST MEASUREMENTS AREA CONFIGURATION FOR NON-PUBLIC NETWORKS

(71) Applicant: Telefonaktiebolaget LM Ericsson (publ), Stockholm (SE)

(72) Inventors: Tahmineh TORABIAN ESFAHANI, Sollentuna (SE); Ali PARICHEHREHTEROUJENI, Linköping (SE); Angelo CENTONZA, Granada (ES); Gautham NAYAK SEETANADI, Stockholm (SE); Marco BELLESCHI, Solna (SE)

(21) Appl. No.: 19/102,391

(22) PCT Filed: Aug. 8, 2023
(86) PCT No.: PCT/SE2023/050792

§ 371 Date: Feb. 8, 2025

Related U.S. Application Data
(60) Provisional application No. 63/396,035, filed on Aug. 8, 2022.

(51) Int. Cl. H04W 24/10

(52) U.S. Cl. CPC H04W 24/10

(57) ABSTRACT

A communication device in a first communications network can determine minimization drive test, MDT, configuration information. The communication device can further determine first MDT measurements associated with the first communications network based on the MDT configuration information. The communication device can further determine second MDT measurements associated with the second communications network based on the MDT configuration information. The communication device can further store a portion of the first MDT measurements and the second MDT measurements based on the MDT configuration information.

### TECHNICAL FIELD

The present disclosure is related to wireless communication systems and more particularly to minimization of drive tests related configuration enhancement.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”)).

Minimization of Drive Tests (“MDT”) was standardized for NR to reduce the amount of drive tests performed manually. It is a UE assisted framework where network measurements are collected by both IDLE/INACTIVE and radio resource control (“RRC”) Connected UE(s) in order to aid the network in gathering valuable information. It has been specified for both Long Term Evolution (“LTE”) and NR.

### SUMMARY

According to some embodiments, a method of operating a communication device in a first communications network is provided. The method includes determining minimization drive test, MDT, configuration information. The method further includes determining first MDT measurements associated with the first communications network based on the MDT configuration information. The method further includes determining second MDT measurements associated with the second communications network based on the MDT configuration information. The method further includes storing a portion of the first MDT measurements and the second MDT measurements based on the MDT configuration information.

According to other embodiments, a method of operating a communication device is provided. The method includes determining MDT measurements associated with a second communications network while the communication device is operating in a first communications network. The method further includes storing the MDT measurements associated with the second communications network. The method further includes, subsequent to storing the MDT measurements associated with the second communications network, entering the second communications network. The method further includes, subsequent to entering the second communications network, deleting the MDT measurements associated with the second communications network based on entering the second communications network.

According to other embodiments, a communication device, computer program, computer program product, non-transitory computer-readable medium, host, or system is provided to perform one of the above methods.

Certain embodiments may provide one or more of the following technical advantages. In some embodiments, area configuration of logged MDT configuration is enhanced so that a network operator can have a better control of granularity of MDT measurements collection in particular when two different networks (e.g., PN and NPN (e.g., PNI-NPN)) are sharing same frequencies or when the UE is able to move in between these two network types.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a table illustrating an example of measurement logging for logged minimization of drive tests (“MDT”);

FIG. 3 is a signal flow diagram illustrating an example of a logged measurement configuration;

FIG. 4 is a diagram illustrating an example of a LoggedMeasurementConfiguration message;

FIG. 5 is a diagram illustrating an example of MDT logging performed by a communication device while T330 is running and T319a is not running;

FIG. 6 is a diagram illustrating an example of a LoggedMeasurementConfiguration information element in accordance with some embodiments;

FIG. 7 is a diagram illustrating an example of an area configuration in accordance with some embodiments;

FIG. 8 is a flow chart illustrating an example of operations performed by a communication device in accordance with some embodiments;

FIG. 9 is a block diagram of a communication system in accordance with some embodiments;

FIG. 10 is a block diagram of a user equipment in accordance with some embodiments;

FIG. 11 is a block diagram of a network node in accordance with some embodiments;

FIG. 12 is a block diagram of a host computer communicating with a user equipment in accordance with some embodiments;

FIG. 13 is a block diagram of a virtualization environment in accordance with some embodiments; and

FIG. 14 is a block diagram of a host computer communicating via a base station with a user equipment over a partially wireless connection in accordance with some embodiments.

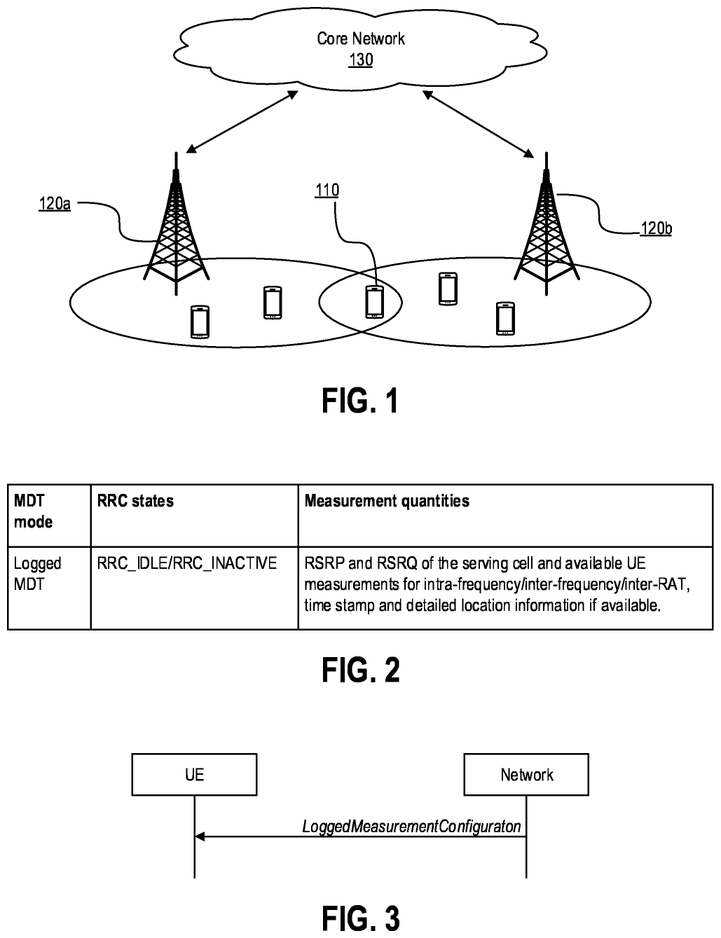

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

In general, there are two types of MDT measurement logging: Logged MDT and Immediate MDT. Logged MDT is described below.

A UE in RRC_IDLE/RRC_INACTIVE state is configured to perform periodical and event triggered MDT logging after receiving the MDT configurations from the network. The UE shall report the downlink (“DL”) pilot strength measurements (reference signal received power (“RSRP”)/reference signal received quality (“RSRQ”)) together with time information, detailed location information if available, and wireless local area network (“WLAN”), BLUETOOTH to the network via using the UE information framework when it is in RRC_CONNECTED state. The DL pilot strength measurement of Logged MDT is collected based on the existing measurements required for cell reselection purpose, without imposing UE to perform additional measurements.

FIG. 2 illustrates an example of measurement logging for logged MDT.

For Periodical Logged MDT, UE receives the MDT configurations including logginginterval and loggingduration in the RRC message (e.g., LoggedMeasurementConfiguration), from the network. A timer (T330) is started at the UE upon receiving the configurations and set to loggingduration (10 min-120 min). The UE shall perform periodical MDT logging with the interval set to logginginterval (1.28 s-61.44 s) when the UE is in RRC_IDLE.

FIG. 3 illustrates an example of a logged measurement configuration. The purpose of this procedure is to configure the UE to perform logging of measurement results while in RRC_IDLE and RRC_INACTIVE. The procedure applies to logged measurements capable UEs that are in RRC_CONNECTED. Next generation radio access network (“NG-RAN”) may retrieve stored logged measurement information by means of the UE information procedure.

In some examples, NG-RAN initiates the logged measurement configuration procedure to UE in RRC_CONNECTED by sending the LoggedMeasurementConfiguration message.

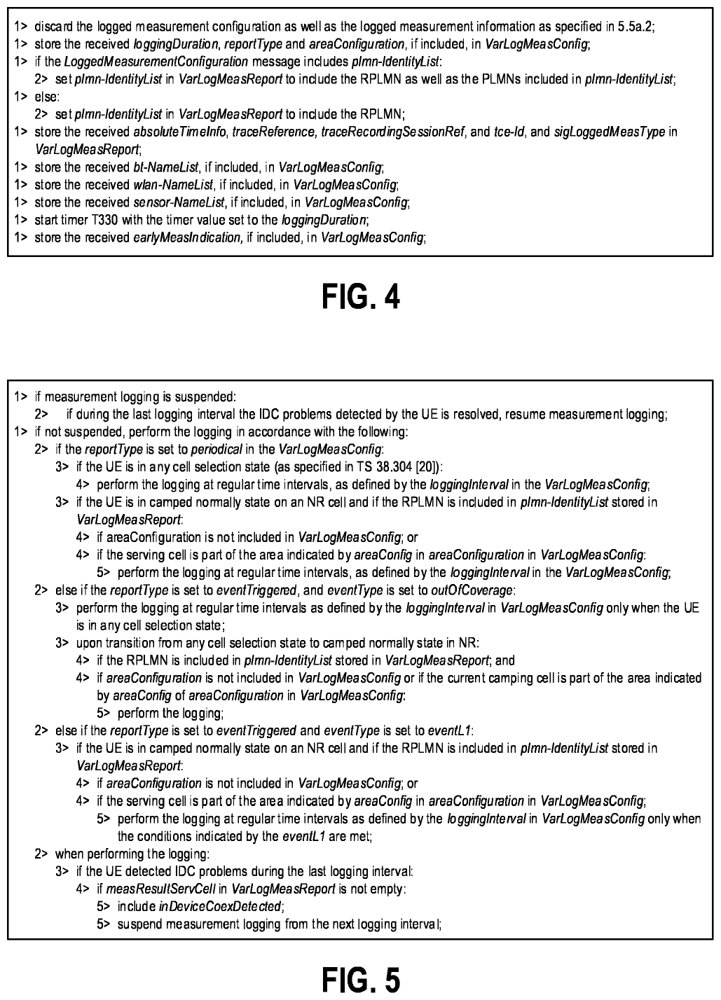

In additional or alternative examples, upon receiving the LoggedMeasurementConfiguration message the UE shall perform the operations of FIG. 4.

In additional or alternative examples, this procedure specifies the logging of available measurements by a UE in RRC_IDLE and RRC_INACTIVE that has a logged measurement configuration. The actual process of logging within the UE, takes place in RRC IDLE state could continue in RRC INACTIVE state or vice versa.

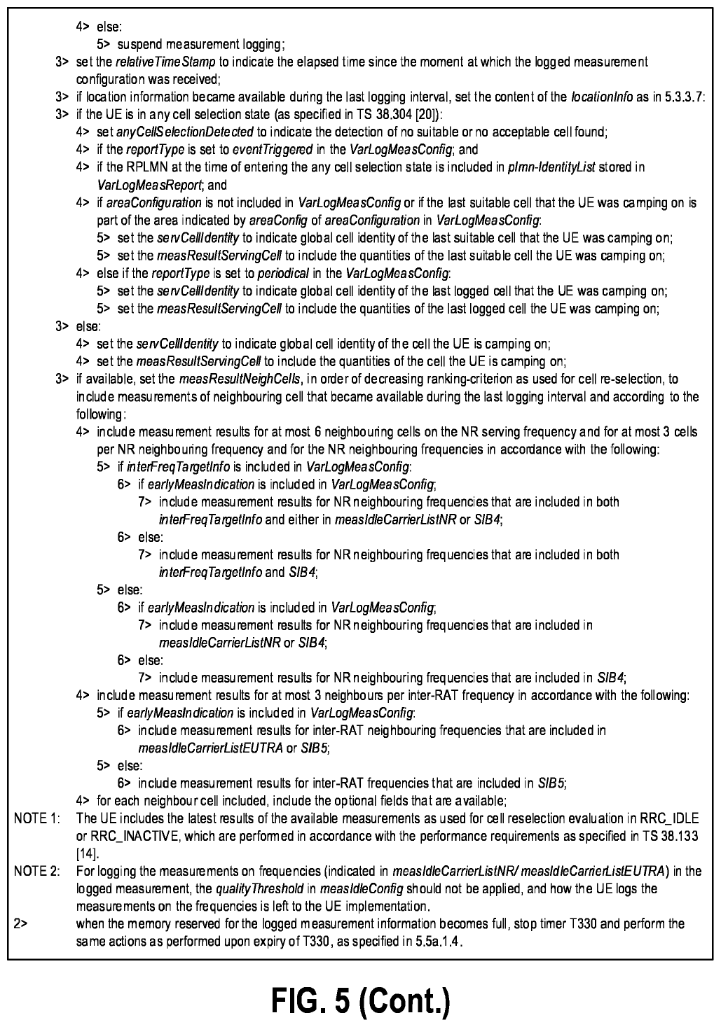

While T330 is running and T319a is not running, the UE shall perform the operations of FIG. 5.

Non-public Networks (“NPN”) are a feature which allows for a network to be deployed and/or managed by an entity other than a normal operator. A “normal operator” here is assumed to be an operator of one or more public land mobile networks (“PLMNs”). It should be noted that a PLMN also has an identifier which is called the PLMN identifier (“ID”), or sometimes just referred to as the “PLMN”.

There are two types of NPN networks, namely stand-alone NPNs (“SNPNs”) and public network integrated-NPNs (“PNI-NPNs”), which are described below.

A first network or network identifier (e.g., a PLMN) can be configured as equivalent to another network or network identifier. For example, the operator of one network has an agreement with another operator such that the users of these networks can consider the network equivalent. There is in current 3^{rd} generations partnership project (“3GPP”) specifications no equivalent NPN networks, but it would be possible to introduce the concept of equivalent NPNs in the future.

SNPN is a flavor of an NPN consisting of a non-PLMN entity. For example, it may be a private company who deploys a network, but that company is not/does not own a PLMN. It could for example be a company who owns factories and deploys networks in and around the factories for the sake of providing service to its employees and machines, etc.

An entity owning an SNPN does not necessarily own its own PLMN. An SNPN network has an identifier which includes a PLMN-identity and a network identity (“NID”). As described above, the entity who owns/manages the SNPN may not have its own PLMN Identity. But since the SNPN includes a PLMN, one way for the SNPN network owner to acquire an SNPN identifier is to make an agreement with a PLMN operator so that they can use the operator's PLMN. Another approach is that a “dummy” (e.g., “special,” “not normally used,” “invalid,” or similar) PLMN is used as part of the identity of the SNPN.

The PNI-NPN feature is another flavor of an NPN. Similar to SNPN, a PNI-NPN may be deployed to offer service to a certain set of users, for example to employees and machines of a company. The main difference between SNPN and PNI-NPN is that a PNI-NPN is integrated into a PLMN. A PNI-NPN may therefore be managed by the operator of the PLMN in which the PNI-NPN is integrated into.

The PNI-NPN has, instead of the NID-identifier which SNPNs use, an identifier called closed access group (“CAG”). A CAG is associated to each cell forming the PNI-NPN. The UEs of the employees, machines, etc. of the company who should be given access to the PNI-NPN are configured with the relevant CAG. Other UEs does not have access to the PNI-NPN and not configured to use the CAG. In the general case, both the UE and the network is performing a check when determining if the UE can connect to a PNI-NPN by looking at if the UE is configured with the CAG and only if that is the case, the UE is given access to the PNI-NPN.

There currently exist certain challenges. In some examples, a UE may have access and subscription to several networks or different network types (e.g., SNPN, PNI-NPNs and PLMNs). Also, a UE can perform registration on a private network (e.g., SNPN) if the UE is capable of services that require specific subscriptions for registration. In general, a UE is successfully registered on a private network (e.g., an SNPN) if (1) the UE has found a suitable cell of the SNPN to camp on; and (2) a registration from the UE has been accepted in the registration area of the cell on which the UE is camped.

Current implementations of MDT measurement collection in 3GPP includes an Operations, Administration, and Maintenance (“OAM”) or a network would not be able to configure a UE to collect MDT measurements associated to a private network (e.g., NPN). Furthermore, a network operator of private network sometimes would like to collect MDT neighbor cells measurements from UEs for other networks (e.g., NPN) that might not have subscriptions to this network. Collection of such neighbor network data may provide information about coverage hole improvements/optimization in the current network. Namely, a comparison of neighbor network signals with current network signal may reveal that the current network is not performing equally well than the neighbor network. This is not possible with the current specifications.

Another use case that is not supported is where the operator of a PLMN may want UEs to collect measurements while they are in an NPN. The UE may indeed report measurements that reveal what is the coverage of the PLMN within the NPN, allowing the operator to optimize coverage of the PLMN. Another reason why a PLMN operator may want UEs in an NPN to collect measurements is that there are more UEs in the neighbor network for data collection compared to the current network. This is not possible with existing solutions.

Certain aspects of the disclosure and their embodiments may provide solutions to these or other challenges. Various embodiments herein provide operations performed by a UE as part of logged MDT framework/procedure for network coverage/performance optimization. The operations can include collecting MDT related information and measurements for a new network type (e.g., NPN) when a UE is registered to either a private network or a public network. The operations can further include collecting MDT measurements associated to a NPN cell that the UE is registered/camped to/on. The operations can further include collecting MDT measurements associated to a neighbor network that UE is not registered to, but UE is configured to collect MDT measurements on target frequencies deployed on neighbor NPN cells. The operations can further include deleting the logged MDT measurements report and/or configuration associated to the old network when UE enters new network and is registered to a new network. The operations can further include maintaining the logged MDT measurements report and/or configuration associated to the old network when UE enters new network and registered to a new network.

In additional or alternative embodiments, the operations are enabled by enhancing the logged MDT configuration. In some examples, the enhancement includes including the NPN identity indication (e.g., NPN-PLMN Identity Info) in the MDT configuration or as part of area scope for the UE. In a additional or alternative examples, the enhancement includes Including the NPN indication in the area scope of the neighboring frequencies (e.g., in the interFreqTargetInfo).

In additional or alternative embodiments, the UE is allowed to log MDT measurements related from different networks with different network types (e.g., public network (“PN”) and NPN) as per received MDT configuration from the OAM or from a network node.

Herein, the terms private networks (e.g., non-private network (“NPN”)) and stand-alone NPN (“SNPN”)/public network integrated-NPN (“PNI-NPN”) nodes are used interchangeably.

PNI-NPN network herein covers the scenario when a cell advertises a PLMN+closed area group (“CAG”) in NPN-Identity in system information block 1 (“SIB1”).

SNPN network herein covers the scenario when a cell advertises a PLMN+network identity (“NID”) in NPN-Identity in SIB1.

It will herein be described how a user equipment (“UE”) (sometimes referred to herein as a communication device) that can get access to different network types (e.g., SNPN, PNI-NPN and PLMNs) shall collect MDT related information. This would imply that the UE has been connected to a cell which is associated with (e.g., broadcasts) an identifier of that NPN (e.g., either an SNPN with a NID identifier or a PNI-NPN with a CAG).

Minimization of drive tests (“MDT”) related information configuration support for NPN are described below.

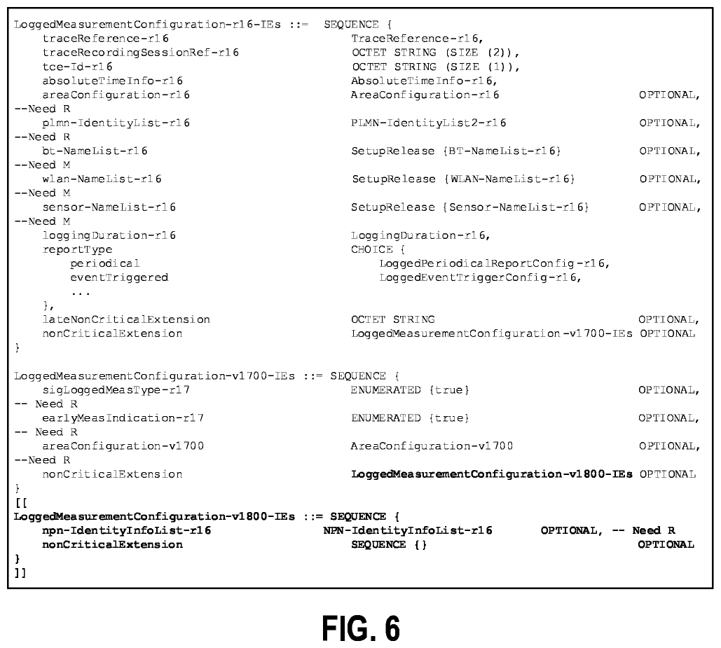

In some embodiments, operations are performed by a UE as part of logged MDT framework for network optimization. FIG. 6 illustrates an example of these operations. The operations include receiving logged MDT configuration from a network node. In some examples, the MDT configuration includes NPN network identities, indicating the area that the UE can camp on and collect the MDT measurements. In additional or alternative examples, the NPN public land mobile network (“PLMN”) identity list can only include PNI-NPN related identities. In additional or alternative examples, the NPN PLMN identity list can only include SNPN related identities. In additional or alternative examples, the NPN PLMN identity list can include both PNI-NPN and SNPN related identities. In additional or alternative examples, the MDT configuration includes PNI-NPN identities and/or SNPN identities, in combination with PLMN identities (e.g., identities associated to a public network)

In some examples, the MDT configuration includes indications in the neighboring frequencies area scope (so-called InterFrequencyTargetInfo), indicating whether the network is interested to collect the NPN cells coverage measurements as part of target frequencies or not. In additional or alternative examples, the network may include in the MDT configuration whether the UE shall log MDT measurements only when it is camped in cells of a specific network (e.g., PNI-NPN or SNPN), or whether the UE shall log measurements from all the cells belonging to the network identities listed in the MDT configuration.

The operations can further include evaluating the logging condition from the received MDT configuration. UE evaluates whether the serving cell measurements can be logged inside logged MDT report for a given logging instance as per received MDT configuration. In some examples, network includes NPN identity as part of the MDT configuration to enable the UE logging the MDT measurements when the UE is connected to the NPN network. If NPN identity (represented by npn-Identity InfoList) presents in the logged MDT configuration, the UE in NPN evaluates whether the serving/camped cell belongs to the list of allowed NPN identities in npn-Identity InfoList-r16 as configured by the network. If yes, the UE logs measurements related to serving cell and/or the neighboring cells in the MDT report. In other words, UE evaluates measurements associated only to a NPN (e.g., PNI-NPN that belongs to the list of allowed NPN identities in npn-Identity InfoList-r16).

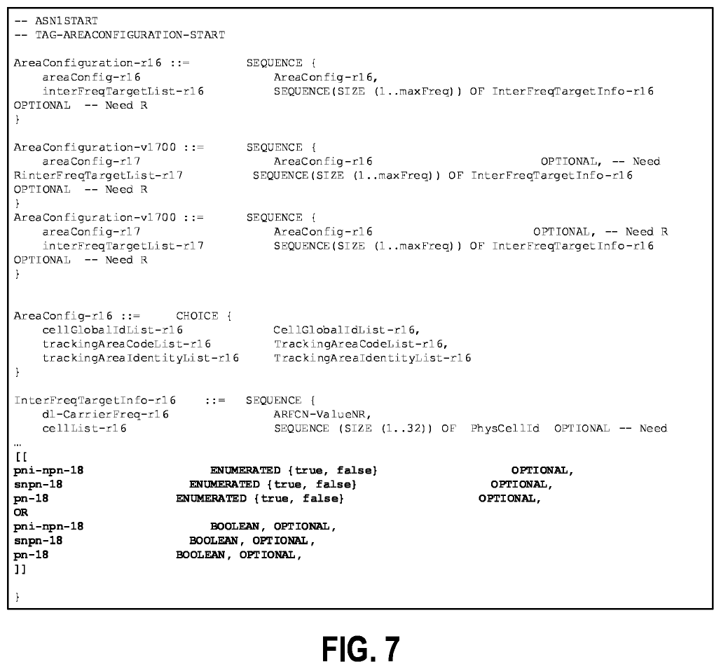

Embodiments related to the enhancement of the MDT configuration concerning neighboring frequencies area scope are illustrated in FIG. 7 and described below. The operations can include evaluating/checking the logging condition included in the received MDT configuration. The evaluation/checking determines whether to include MDT related measurements associated to the neighbor cells from other network type per each configured carrier frequency (configured as part of InterFreqTargetInfo) when two neighbor cells from different network share the carrier frequency.

In some embodiments, if InterFreqTargetInfo is present, a UE in PN evaluates measurements associated to nterFreqTargetInfoand/or allowed PLMN identities presented in plmn-IdentityList. The network configuration may restrict the UE to only collect MDT measurement associated to the neighbor PN cells on the configured target carrier frequencies.

In additional or alternative embodiments, if InterFreqTargetInfo is present, a UE in PN evaluates measurements associated to InterFreqTargetInfo and/or allowed PLMN identities presented in plmn-IdentityList. The network configuration may restrict the UE to only collect MDT measurement associated to the neighbor NPN cells on the configured target carrier frequencies. In some examples, for collecting NPN related MDT measurements, UE reads the list of intra-frequency neighboring CAG cells in SIB3 and matches the measured PCI with PCI broadcasted in SIB3 for a neighbor PNI-NPN cells. In additional or alternative examples, for collecting NPN related MDT measurements, UE reads the list of inter-frequency neighboring CAG cells in SIB4 and matches the measured PCI with PCI broadcasted in SIB4 for a neighbor PNI-NPN cells.

In additional or alternative embodiments, a UE in PN evaluates measurements associated to InterFreqTargetInfo and/or allowed PLMN identities presented in plmn-IdentityList. The network configuration may request the UE to collect MDT measurement associated to both the neighbor PN and NPN cells separately on the configured target carrier frequencies. In some examples, for collecting NPN related MDT measurements, UE reads the list of intra-frequency neighboring CAG cells in SIB3 and matches the measured PCI with PCI broadcasted in SIB3 for a neighbor PNI-NPN cells. In additional or alternative examples, for collecting NPN related MDT measurements, UE reads the list of inter-frequency neighboring CAG cells in SIB4 and matches the measured PCI with PCI broadcasted in SIB4 for a neighbor PNI-NPN cells.

In additional or alternative embodiments, a UE in NPN evaluates measurements associated to InterFreqTargetInfo and/or allowed NPN identities presented in npn-IdentityInfoList-r18. The network configuration may restrict the UE to only collect MDT measurement associated to the neighbor NPN cells on the configured target carrier frequencies.

In additional or alternative embodiments, a UE in NPN evaluates measurements associated to InterFreqTargetInfo and/or allowed NPN identities presented in npn-Identity InfoList-r18. The network configuration may restrict the UE to only collect MDT measurement associated to the neighbor PN cells on the configured target carrier frequencies.

In additional or alternative embodiments, a UE in NPN evaluates measurements associated to InterFreqTargetInfo and/or allowed NPN identities presented in npn-IdentityInfoList-r18. The network configuration may request the UE to collect MDT measurement associated to both the neighbor PN and NPN cells separately on the configured target carrier frequencies.

Operations performed by UE to perform MDT related measurement results for inter PN-NPN mobility are described below.

In some embodiments, a UE that enters NPN from PN deletes the NPN logged MDT measurement results immediately. The UE is therefore able to report only measurements collected while camping in the NPN to the RAN forming the NPN. Moreover, UE continues to perform MDT measurements in NPN if the determination is that the UE should activate or continue to perform MDT measurement.

In additional or alternative embodiments, a UE that enters PN from NPN deletes the NPN logged MDT measurement results immediately. The UE is therefore able to report only measurements collected while camping in the PN to the RAN forming the PN. Moreover, UE continues to perform MDT measurements in PN if the determination is that the UE should activate or continue to perform MDT measurement.

In additional or alternative embodiments, a UE that enters NPN from PN maintains the NPN logged MDT and may delete the logged MDT associated from NPN after a certain time. In addition, UE continues to perform MDT measurements in NPN if the determination is that the UE should activate or continue to perform MDT measurement. In some examples, the UE may report to the network on which it is camping (NPN) both logged measurements collected while in PM and while in NPN. In additional or alternative examples, the UE may report to the network where it is camping measurements collected while in the camping network, (e.g., NPN), while it reports measurements collected while in the previous camping network to a RAN node forming the previously camping network. The latter means that the UE reports the measurements collected while in the previous camping network when it returns to a PN.

In additional or alternative embodiments, a UE that enters PN from NPN maintains the PN logged MDT and may delete the logged MDT associated from PN after a certain time. In addition, UE continues to perform MDT measurements in PN if the determination is that the UE should activate or continue to perform MDT measurement. In some examples, the UE may report to the network on which it is camping (PN) both logged measurements collected while in PM and while in NPN. Alternatively, the UE may report to the network where it is camping measurements collected while in the camping network (e.g., PN), while it reports measurements collected while in the previous camping network to a RAN node forming the previously camping network. The latter means that the UE reports the measurements collected while in the previous camping network when it returns to a NPN.

In additional or alternative embodiments, a UE enters a new network and the new network configures UE with the timer value—the time that UE should keep the MDT related information associated to the old network. Such configuration happens via broadcasting the timer value via system information.

In additional or alternative embodiments, a UE enters a new network after old network configured UE with the timer value—the time that UE should keep the MDT related information associated to the old network. Such configuration happens via broadcasting the timer value via system information.

In additional or alternative embodiments, a UE enters a new network after an old network configures the UE with the timer value—the time that UE should keep the MDT related information. Such configuration happens via dedicated configuration via RRC messages.

In additional or alternative embodiments, a UE enters a new network and a new network configures UE with the timer value—the time that UE should keep the MDT related information. Such configuration happens via dedicated configuration via RRC messages.

In additional or alternative embodiments, a UE enters a new network and the UE logs NPN and PN measurement results separately in a separate variable.

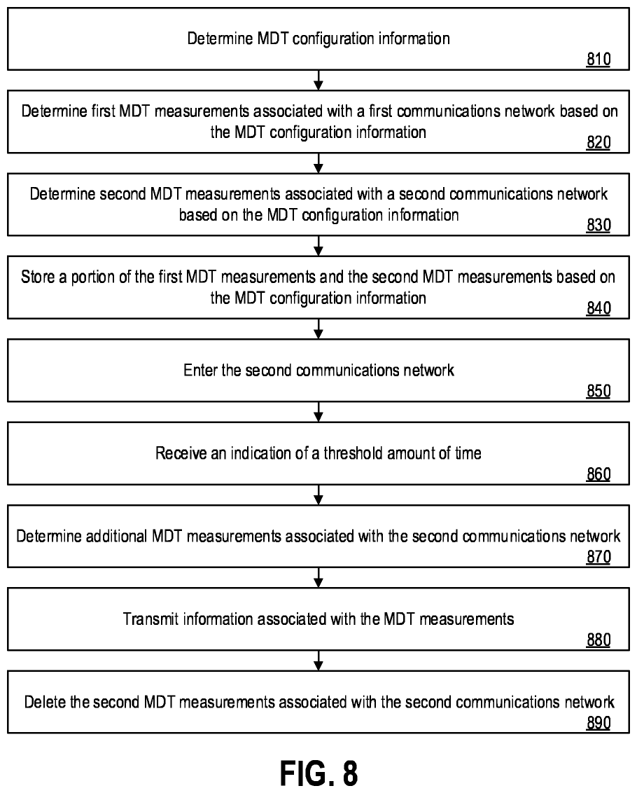

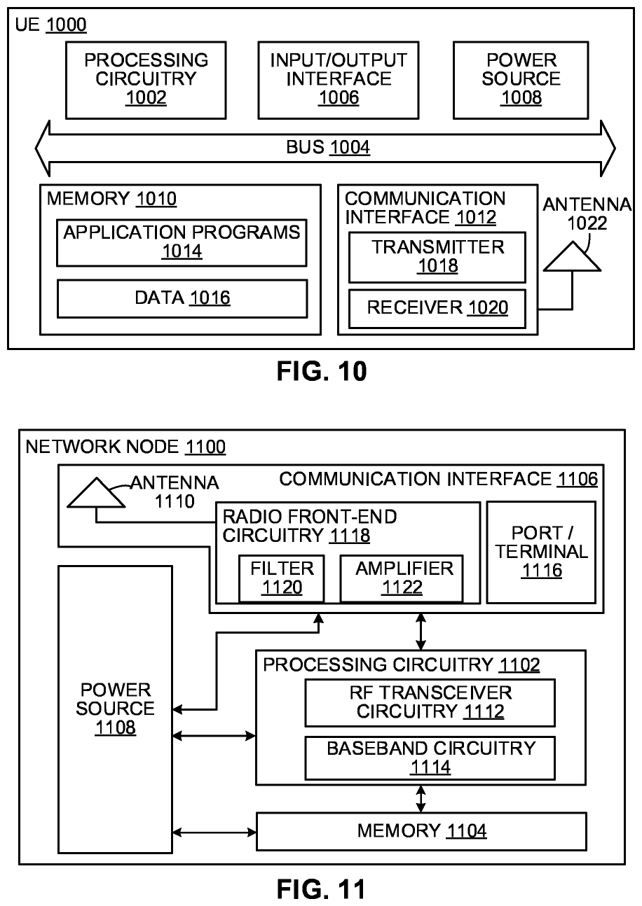

In the description that follows, while the communication device may be any of wireless device 912A-B, wireless devices UE 912C-D, UE 1000, virtualization hardware 1304, virtual machines 1308A, 1308B, or UE 1406, the UE 1000 (also referred to herein as communication device 1000) shall be used to describe the functionality of the operations of the communication device. Operations of the communication device 1000 (implemented using the structure of the block diagram of FIG. 10) will now be discussed with reference to the flow chart of FIG. 8 according to some embodiments of inventive concepts. For example, modules may be stored in memory 1010 of FIG. 10, and these modules may provide instructions so that when the instructions of a module are executed by respective communication device processing circuitry 1002, processing circuitry 1002 performs respective operations of the flow charts.

FIG. 8 illustrates operations performed by a communication device.

At block 810, processing circuitry 1002 determines MDT configuration information. In some embodiments, determining the MDT configuration information includes receiving the MDT configuration information from the first communications network.

At block 820, processing circuitry 1002 determines first MDT measurements associated with a first communications network based on the MDT configuration information.

At block 830, processing circuitry 1002 determines second MDT measurements associated with a second communications network based on the MDT configuration information. In some embodiments, the MDT configuration information includes an indication of an area that the communication device is allowed to collect the second MDT measurements.

In additional or alternative embodiments, the indication of the area includes a non-public network, NPN, public land mobile network, PLMN, identities list. In some examples, determining the second MDT measurements includes determining the second MDT measurements based on the second communications network being on the NPN PLMN identities list. In additional or alternative examples, the NPN PLMN identities list includes a at least one of: public network integrated-NPN, PNI-NPN, identities; standalone NPN, SNPN, identities; and PLMN identities.

In additional or alternative embodiments, the indication of the area includes an indication of a target frequency to use to collect the second MDT measurements. In some examples, determining the second MDT measurements includes determining the second MDT measurements using the target frequency.

At block 840, processing circuitry 1002 stores a portion of the first MDT measurements and the second MDT measurements based on the MDT configuration information. In some embodiments, the MDT configuration information includes an indication that the communication device only store MDT measurements when it is camped on a specific type of communications network or a specific communications network.

At block 850, processing circuitry 1002 enters the second communications network.

At block 860, processing circuitry 1002 receives an indication of a threshold amount of time. In some embodiments, the indication is received from the first communications network via at least one of a broadcast signal and a dedicated radio resource control, RRC message. In additional or alternative embodiments, the indication is received from the second communications network via at least one of a broadcast signal and a dedicated radio resource control, RRC message.

At block 870, processing circuitry 1002 determines additional MDT measurements associated with the second communications network.

At block 880, processing circuitry 1002 transmits information associated with the MDT measurements. In some embodiments, transmitting the information associated with the MDT measurements includes: prior to deleting the first MDT measurements associated with the second communications network, transmitting information associated with the first MDT measurements to the first communications network; and prior to deleting the first MDT measurements associated with the second communications network, transmitting information associated with the second MDT measurements to the second communications network. In additional o alternative embodiments, transmitting the information associated with the MDT measurements includes: prior to deleting the first MDT measurements associated with the second communications network, transmitting information associated with the first MDT measurements to the second communications network; and prior to deleting the first MDT measurements associated with the second communications network, transmitting information associated with the second MDT measurements to the second communications network.

At block 890, processing circuitry 1002 deletes the second MDT measurements associated with the second communications network. In additional or alternative embodiments, deleting the MDT measurements associated with the second communications network includes deleting the MDT measurements after a threshold amount of time has elapsed since the communication device entered the second communications network.

In some embodiments, the first communications network is separate from the second communications network. In additional or alternative embodiments, only one of the first communications network and the second communications network is a public network, PN, and the other is a non-public network, NPN. In some examples, the NPN includes at least one of: a standalone NPN, SNPN; and a public network integrated-NPN, PNI-NPN.

Various operations illustrated in FIG. 8 may be optional in respect to some embodiments.

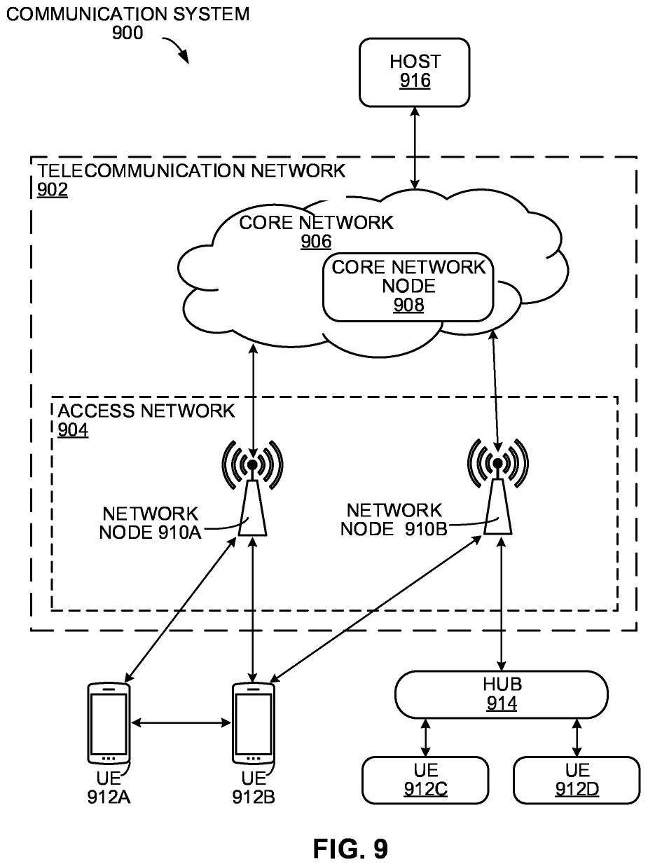

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access node or non-3GPP access point. Moreover, as will be appreciated by those of skill in the art, the network nodes 910 are not necessarily limited to an implementation in which a radio portion and a baseband portion are supplied and integrated by a single vendor. Thus, it will be understood that the network nodes 910 may include disaggregated implementations or portions thereof. For example, in some embodiments, the telecommunication network 902 includes one or more Open-RAN (ORAN) network nodes. An ORAN network node is a node in the telecommunication network 902 that supports an ORAN specification (e.g., a specification published by the O-RAN Alliance, or any similar organization) and may operate alone or together with other nodes to implement one or more functionalities of any node in the telecommunication network 902, including one or more network nodes 910 and/or core network nodes 908.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 910 facilitate direct or indirect connection of user equipment (UE), such as by connecting wireless devices 912a, 912b, 912c, and 912d (one or more of which may be generally referred to as UEs 912) to the core network 906 over one or more wireless connections. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WI-FI); and/or any other appropriate wireless communication standard, such as the Worldwide Interoperability for Microwave Access (WIMAX), BLUETOOTH, Z-Wave, Near Field Communication (NFC) ZIGBEE, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as BLUETOOTH, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WIMAX, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WI-FI, ZIGBEE, Z-wave, LoRaWAN, Radio Frequency Identification (RFID) or BLUETOOTH wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

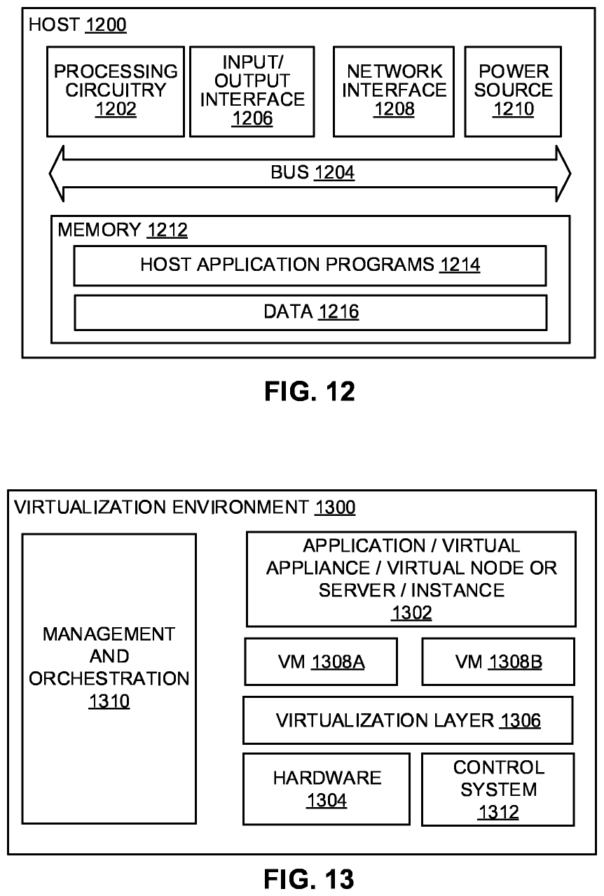

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1300 includes components defined by the O-RAN Alliance, such as an O-Cloud environment orchestrated by a Service Management and Orchestration Framework via an O-2 interface.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

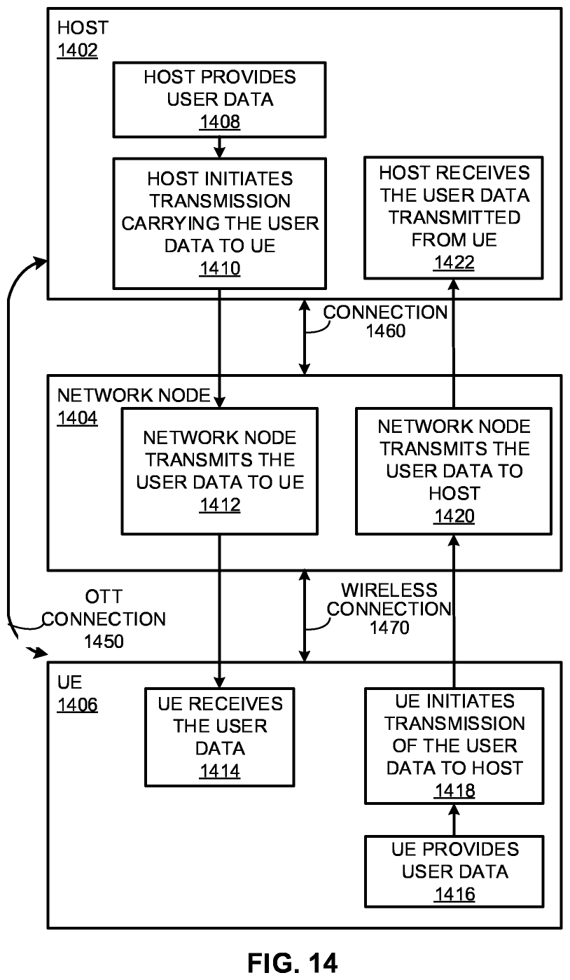

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, area configuration of logged MDT configuration is enhanced so that a network operator can have a better control of granularity of MDT measurements collection in particular when two different networks (e.g., PN and NPN (e.g., PNI-NPN)) are sharing same frequencies or when the UE is able to move in between these two network types.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

What is claimed is:

1. A method of operating a communication device in a first communications network, the method comprising:
determining minimization drive test, MDT, configuration information;
determining first MDT measurements associated with the first communications network based on the MDT configuration information;
determining second MDT measurements associated with the second communications network based on the MDT configuration information; and
storing a portion of the first MDT measurements and the second MDT measurements based on the MDT configuration information.

2. The method of claim 1, wherein determining the MDT configuration information comprises receiving the MDT configuration information from the first communications network.

3. The method of claim 1, wherein the MDT configuration information includes an indication of an area that the communication device is allowed to collect the second MDT measurements.

4. (canceled)

5. The method of claim 3, wherein the indication of the area comprises a non-public network, NPN, public land mobile network, PLMN, identities list, and
wherein determining the second MDT measurements comprises determining the second MDT measurements based on the second communications network being on the NPN PLMN identities list.

6. The method of claim 5, wherein the NPN PLMN identities list includes at least one of:
public network integrated-NPN, PNI-NPN, identities;
standalone NPN, SNPN, identities; and
PLMN identities.

7-8. (canceled)

9. The method of claim 3, wherein the indication of the area comprises an indication of a target frequency to use to collect the second MDT measurements, and
wherein determining the second MDT measurements comprises determining the second MDT measurements using the target frequency.

10. The method of claim 1, wherein the MDT configuration information includes an indication that the communication device only store MDT measurements when it is camped on a specific type of communications network or a specific communications network.

11. The method of claim 1, wherein the first communications network is separate from the second communications network, and
wherein only one of the first communications network and the second communications network is a public network, PN, and the other is a non-public network, NPN.

12. A method of operating a communication device, the method comprising:
determining MDT measurements associated with a second communications network while the communication device is operating in a first communications network;
storing the MDT measurements associated with the second communications network;
subsequent to storing the MDT measurements associated with the second communications network, entering the second communications network; and
subsequent to entering the second communications network, deleting the MDT measurements associated with the second communications network based on entering the second communications network.

13. The method of claim 12, wherein the MDT measurements associated with the second communications network are first MDT measurements associated with the second communications networks determined while the communication device is operating in the first communications network,
the method further comprising:
subsequent to entering the second communications network, determining second MDT measurements associated with the second communications network while the communication device is operating in the second communications network.

14. The method of claim 13, further comprising:
prior to deleting the first MDT measurements associated with the second communications network, transmitting information associated with the first MDT measurements to the first communications network; and
prior to deleting the first MDT measurements associated with the second communications network, transmitting information associated with the second MDT measurements to the second communications network.

15. The method of claim 13, further comprising:
prior to deleting the first MDT measurements associated with the second communications network, transmitting information associated with the first MDT measurements to the second communications network; and
prior to deleting the first MDT measurements associated with the second communications network, transmitting information associated with the second MDT measurements to the second communications network.

16. The method of claim 12, wherein deleting the MDT measurements associated with the second communications network comprises deleting the MDT measurements after a threshold amount of time has elapsed since the communication device entered the second communications network.

17. The method of claim 16, further comprising:
receiving an indication of the threshold amount of time from the first communications network via at least one of a broadcast signal and a dedicated radio resource control, RRC message.

18. The method of claim 16, further comprising:
receiving an indication of the threshold amount of time from the second communications network via at least one of a broadcast signal and a dedicated radio resource control, RRC message.

19. The method of claim 12, wherein the first communications network comprises a public network, PN, and
wherein the second communications network comprises a non-public network, NPN.

20. The method of claim 12, wherein the first communications network comprises a non-public network, NPN, and
wherein the second communications network comprises public network, PN.

21. The method of claim 19, wherein the NPN comprises at least one of:
a standalone NPN, SNPN; and
a public network integrated-NPN, PNI-NPN.

22. (canceled)

23. A communication device operating in a communications network, the communication device comprising:
processing circuitry; and
memory coupled to the processing circuitry and having instructions stored therein that are executable by the processing circuitry to cause the communication device to perform operations comprising
determine minimization drive test, MDT, configuration information;
determine first MDT measurements associated with the first communications network based on the MDT configuration information;
determine second MDT measurements associated with the second communications network based on the MDT configuration information; and
store a portion of the first MDT measurements and the second MDT measurements based on the MDT configuration information.

24-25. (canceled)

26. A non-transitory computer-readable medium having instructions stored therein that are executable by processing circuitry of a communication device operating in a communications network to cause the communication device to perform operations comprising
determine minimization drive test, MDT, configuration information;
determine first MDT measurements associated with the first communications network based on the MDT configuration information;
determine second MDT measurements associated with the second communications network based on the MDT configuration information; and
store a portion of the first MDT measurements and the second MDT measurements based on the MDT configuration information.
